(19) United States
(12) Patent Application Publication
(10) Pub. No.: US 2014/0369786 A1
(43) Pub. Date: Dec. 18, 2014

(54) ANTI-LOOSENING NUT

(71) Applicant: KABO TOOL COMPANY, Taichung City (TW)

(72) Inventor: Chih-Ching HSIEH, Taichung City (TW)

(21) Appl. No.: 14/299,275

(22) Filed: Jun. 9, 2014

(30) Foreign Application Priority Data
Jun. 17, 2013 (TW) 102121375

(51) Int. Cl. F16B 39/34

(52) U.S. Cl. CPC F16B 39/34
USPC 411/247

(57) ABSTRACT

An anti-loosening nut is formed with a threaded hole. The wall of the threaded hole is formed with at least one receiving cavity formed on the wall of the threaded hole in an axial direction of the threaded hole. At least one holding member is mounted in the receiving cavity of the nut. The holding member is disposed in the receiving cavity of the nut in the axial direction of the nut. When the nut is screwed onto a screw/bolt, the holding member elastically holds the screw/bolt, whereby the nut and the screw are elastically tightened with each other to avoid loosening of the nut.

### BACKGROUND OF THE INVENTION

1. Field of the Invention

The present invention relates generally to a nut, and more particularly to an anti-loosening nut.

2. Description of the Related Art

The conventional screw/bolt and nut serve as a locking and tightening structure for locating and fixedly connecting mechanical components. Such locking and tightening structure is advantageous in that the screw and nut can be repeatedly tightened and untightened. However, in the case that the screw and the nut bear varying load or are subject to frequent vibration, the nut is often unexpectedly loosened from the screw to cause unnecessary trouble and loss. Especially, when the screw and nut are applied to a high-speed transportation tool or mechanical apparatus, the loosening of the nut may seriously threaten safety of human lives. Therefore, it is a critical issue how to prevent the nut from loosening from the screw.

Please refer to FIG. 11, which shows a conventional anti-loosening structure for a nut. After the screw/bolt 50 is passed through an article 51 to be fixed, a spring washer 52 is previously fitted around the screw 50. Then the nut 53 is screwed onto the screw 50 to compress and tighten the spring washer 52. In this case, the spring washer 52 is elastically compressed between the nut 53 and the article 51 to prevent the nut 53 from loosening.

The above conventional anti-loosening structure for the nut can be seen everywhere in our daily life. The anti-loosening structure is such designed that the spring washer 52 is elastically compressed between the outer circumference of the nut and the article to avoid loosening.

Please refer to FIG. 12, which shows another conventional anti-loosening structure for a nut. In this anti-loosening structure, a C-shaped ring 60 is mounted in the threaded hole of the nut 61. After the nut 61 is screwed onto the screw/bolt 62, the C-shaped ring 60 is positioned in a receiving space of the nut 61 and engaged between the inner thread 611 of the nut 61 and the outer thread 621 of the screw 62 to avoid loosening of the nut 61 from the screw 62.

In the above conventional anti-loosening structure, the C-shaped ring is positioned in a gap between the nut and the screw and the circumference of the C-shaped ring is engaged between the nut and the screw to avoid loosening of the nut from the screw. However, when screwing the nut onto the screw, the C-shaped ring will abrade the inner thread of the nut and the outer thread of the screw so that it is quite inconvenient to tighten the nut with the screw. Moreover, in some cases, the nut will clog due to the C-shaped ring blocking up the nut and the screw.

It is therefore tried by the applicant to provide an anti-loosening nut to solve the above problems.

### SUMMARY OF THE INVENTION

It is therefore a primary object of the present invention to provide an anti-loosening nut having at least one holding member. At least one receiving cavity is formed on the wall of the threaded hole of the nut in an axial direction of the threaded hole. The holding member is disposed in the receiving cavity in the axial direction of the threaded hole.

It is a further object of the present invention to provide the above anti-loosening nut in which the holding member elastically holds the screw rather than engaged therewith so that when screwing the nut onto the screw, the nut will not clog.

To achieve the above and other objects, the anti-loosening nut of the present invention is formed with a threaded hole. The wall of the threaded hole is formed with at least one receiving cavity formed on the wall of the threaded hole in an axial direction of the threaded hole. At least one holding member, which is a leaf spring, is mounted in the receiving cavity of the nut. The leaf spring is formed with at least one holding section for elastically abutting against the outer thread of a screw.

The holding member is axially disposed in the receiving cavity of the nut to elastically hold the screw. This is different from the conventional structure in which a C-shaped ring is engaged between the inner thread of the nut and the outer thread of the screw. The leaf spring elastically abuts against the outer thread of the screw rather than engages with the outer thread of the screw. Therefore, the nut and the screw are elastically tightened with each other. In this case, when screwing the nut onto the screw, the nut will not clog.

Alternatively, the anti-loosening nut of the present invention is formed with a threaded hole. The wall of the threaded hole is formed with at least one receiving cavity formed on the wall of the threaded hole in an axial direction of the threaded hole. The nut has at least one holding member, which has the form of an elongated bar. The holding member has a first surface and a second surface respectively positioned on a front face and a back face of the holding member. The holding member is disposed in the receiving cavity of the nut. A longitudinal direction of the holding member extends along a longitudinal direction of the receiving cavity. The first surface faces the threaded hole and is made of a soft material. The second surface faces the receiving cavity. The first surface elastically abuts against the outer thread of the screw.

The holding member is axially disposed in the receiving cavity of the nut to elastically hold the screw. This is different from the conventional structure in which a C-shaped ring is engaged between the inner thread of the nut and the outer thread of the screw. The holding member is elastically flexed and deformed to hold or engage with the outer thread of the screw, whereby the nut and the screw are elastically tightened with each other rather than engaged with each other. Therefore, when screwing the nut onto the screw, the nut will not clog.

The present invention can be best understood through the following description and accompanying drawings, wherein:

### BRIEF DESCRIPTION OF THE DRAWINGS

FIG. 1 is a perspective view of the leaf spring of a first embodiment of the present invention;

FIG. 2 is a sectional view showing that the leaf spring of the first embodiment of the present invention is positioned in the nut;

FIG. 3 is a sectional view showing that the first embodiment of the nut of the present invention is screwed on a screw;

FIG. 4 is a sectional view taken along line 4-4 of FIG. 3;

FIG. 5 is a sectional view showing that a second embodiment of the nut of the present invention is screwed on a screw;

FIG. 6 is a perspective view of the holding member of a third embodiment of the present invention;

FIG. 7 is a sectional view showing that the holding member of the third embodiment of the present invention is positioned in the nut;

FIG. 8 is a sectional view showing that the third embodiment of the nut of the present invention is screwed on a screw;

FIG. 9 is a sectional view taken along line 9-9 of FIG. 8;

FIG. 10 is a sectional view showing that the holding member of a fourth embodiment of the present invention is positioned in the nut;

FIG. 11 is a sectional view showing a conventional anti-loosening structure for a nut; and

FIG. 12 is a sectional view showing another conventional anti-loosening structure for a nut.

### DETAILED DESCRIPTION OF THE PREFERRED EMBODIMENTS

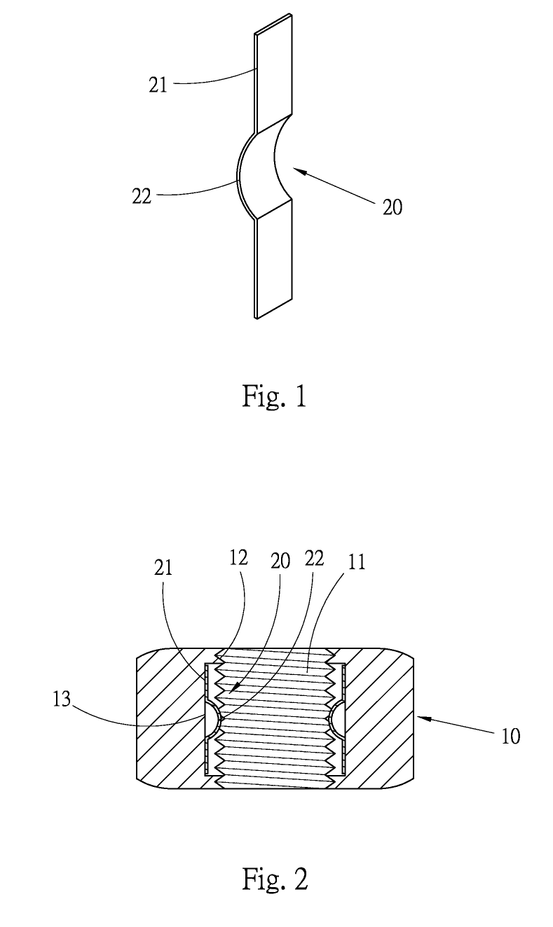

Please refer to FIGS. 1 and 2. According to a first embodiment, the anti-loosening nut 10 of the present invention is formed with a threaded hole 11. The wall of the threaded hole 11 is formed with an inner thread 12. The nut 10 is further formed with at least one receiving cavity 13 formed on the wall of the threaded hole 11 in an axial direction of the threaded hole 11. In this embodiment, there are two receiving cavities 13 arranged at 180-degree angular intervals. Preferably, two ends of each receiving cavity 13 are closed ends without extending to the end faces of the nut.

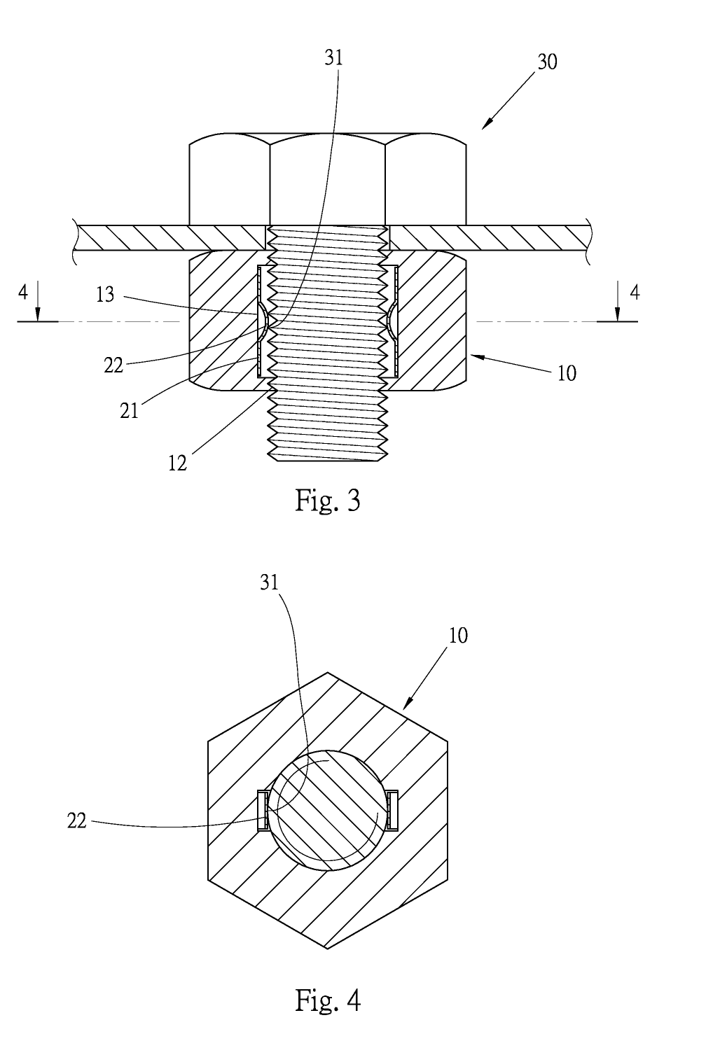

The first embodiment of the anti-loosening nut 10 of the present invention includes at least one holding member 20. The holding member 20 is an elongated leaf spring 21 made of metal material with elasticity or flexibility. In this embodiment, there are two leaf springs 21 positioned in the receiving cavities 13 of the nut 10 respectively. The leaf springs 21 are mounted in the receiving cavities 13 by means of elastic engagement. Alternatively, two ends of each leaf spring 21 respectively abut against two ends of the receiving cavity 13 to locate the leaf spring 21 therein. Each leaf spring 21 is formed with a holding section 22 slightly protruding from the receiving cavity 13 into the threaded hole 11 for abutting against the outer thread 31 of a screw 30 as shown in FIG. 3.

Please refer to FIGS. 3 and 4. In use of the first embodiment of the nut 10 of the present invention, the nut 10 and the screw/bolt 30 are screwed on an article to be fixed, especially on a part of a high-speed transportation tool such as a vehicle, an airplane, a boat or a mechanical apparatus that will severely vibrate in operation. The inner thread 12 of the nut 10 is screwed on the outer thread 31 of the screw 30. At this time, the holding sections 22 of the two leaf springs 21 elastically abut against the outer thread 31 of the screw 30, whereby the screw 30 and the nut 10 are elastically tightened with each other. Under such circumstance, the nut 10 is prevented from loosening from the screw 30 due to severe vibration. In this case, the loosening of the part of the transportation tool or mechanical apparatus can be avoided so as to ensure safety.

The leaf springs 21 are axially disposed in the receiving cavities 13 of the nut 10 to elastically abut against the outer thread 31 of the screw 30. Accordingly, the screw 30 and the nut 10 are elastically tightened with each other. This is different from the prior art in which the C-shaped ring 60 is engaged between the inner thread 611 of the nut 61 and the outer thread 621 of the screw 62. Moreover, the leaf springs 21 elastically abut against (hold) the surface of the screw 30, whereby the nut 10 and the screw 31 are elastically tightened with each other rather than engaged with each other. Therefore, when screwing the nut 10 onto the screw 30, the nut 10 will not clog due to the leaf springs 21.

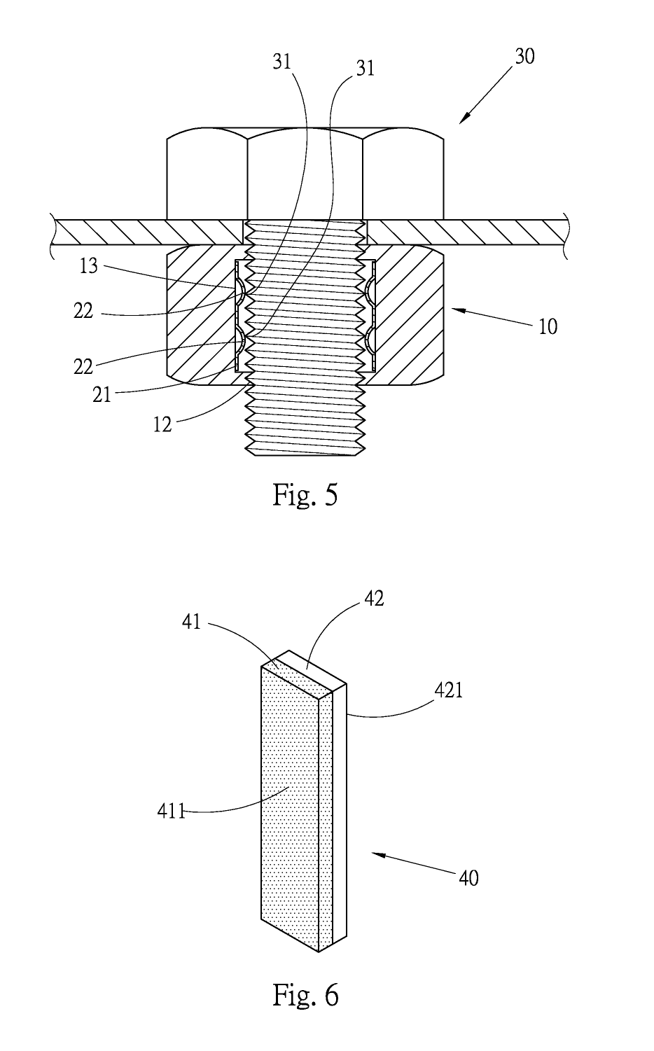

Please now refer to FIG. 5, which shows a second embodiment of the anti-loosening nut 10 of the present invention.

In this embodiment, two holding members, which are two leaf springs 21 are similarly mounted in the threaded hole 11 of the nut 10. Each leaf spring 21 is formed with two holding sections 22 for elastically abutting against/holding the outer thread 31 of the screw 30. Under such circumstance, a stronger elastic holding force is applied between the nut 10 and the screw 30 to prevent the nut 10 from loosening from the screw 30. As necessary, the leaf spring 21 can be formed with more than two holding sections 22.

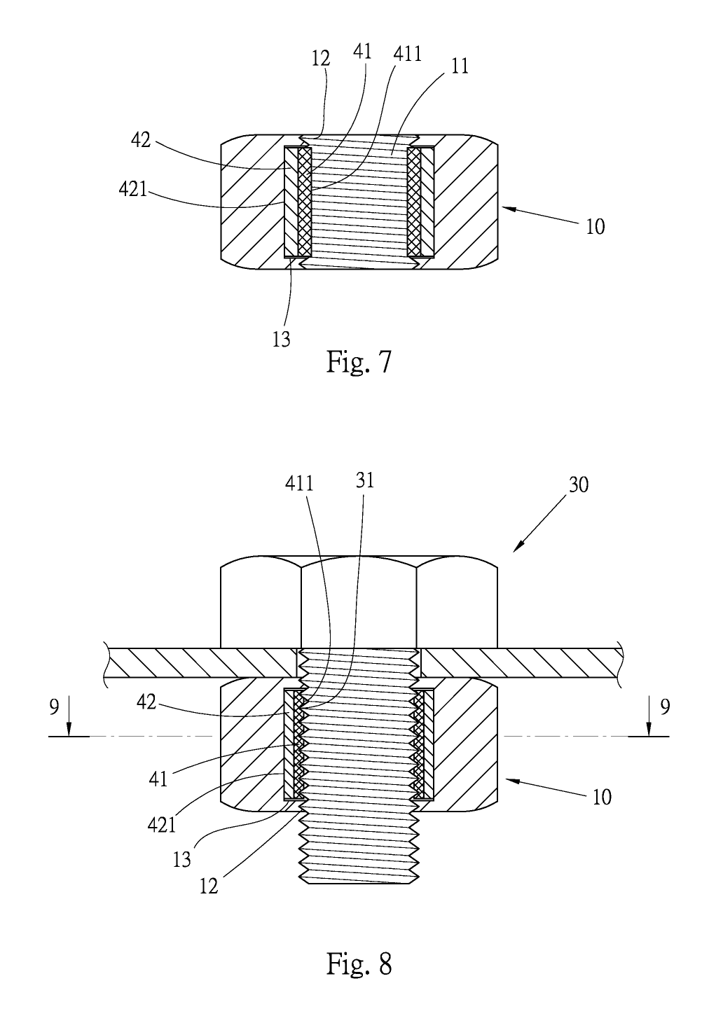

Please now refer to FIGS. 6 and 7, which show a third embodiment of the anti-loosening nut 10 of the present invention.

In this embodiment, the nut 10 is formed with a threaded hole 11. The wall of the threaded hole 11 is formed with an inner thread 12. The nut 10 is further formed with at least one receiving cavity 13 formed on the wall of the threaded hole 11 in an axial direction of the threaded hole 11. In this embodiment, there are two receiving cavities 13 arranged at 180-degree angular intervals.

The third embodiment of the anti-loosening nut 10 of the present invention includes at least one holding member 40. The holding member 40 has the form of an elongated bar having a front face as a first surface 411 and a back face as a second surface 421. To speak more specifically, the holding member 40 is composed of a first material layer 41 and a second material layer 42. The first and second material layers 41, 42 are overlapped and connected with each other. The holding member 40 is positioned in the receiving cavity 13 of the nut 10. A longitudinal direction of the holding member 40 extends along a longitudinal direction of the receiving cavity 13. The surface of the first material layer 41 of the holding member 40 forms the first surface 411, which faces the threaded hole 11. The first material layer 41 is made of a soft, flexible or elastic material such as plastic or rubber. Accordingly, the first surface 411 is a soft or flexible surface. Preferably, the first material layer 42 of the holding member 40 slightly protrudes from the receiving cavity 13 to abut against/contact the outer thread 31 of the screw 30. The surface of the second material layer 42 of the holding member 40 forms the second surface 421, which faces the receiving cavity 13. The second material layer 42 is made of a hard material such as metal.

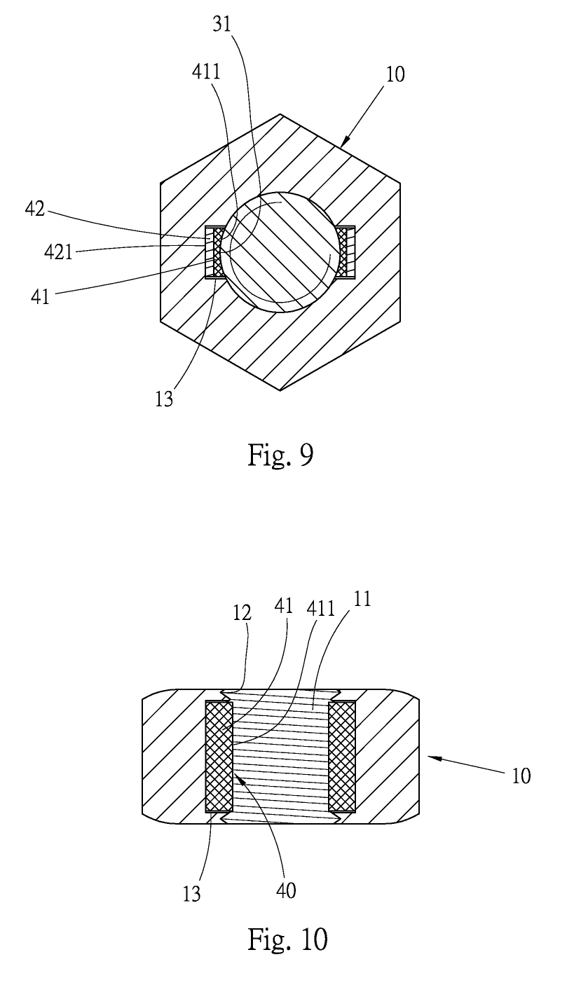

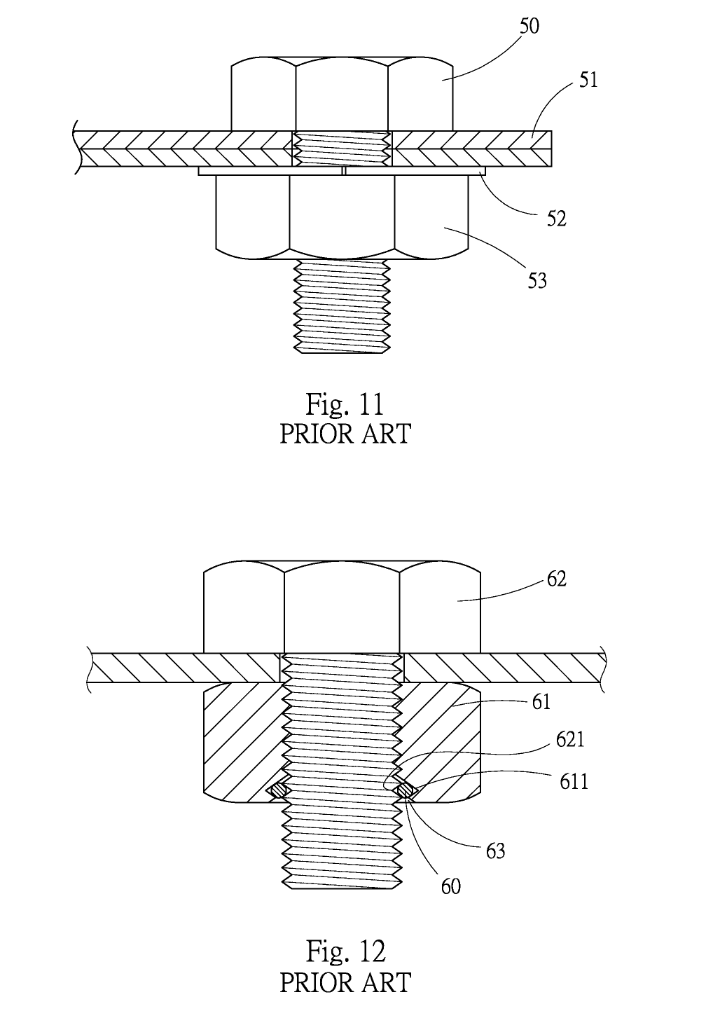

Please now refer to FIGS. 8 and 9. In use of the third embodiment of the anti-loosening nut 10 of the present invention, the nut 10 and the screw/bolt 30 are screwed on an article to be fixed. The inner thread 12 of the nut 10 is screwed on the outer thread 31 of the screw 30. At this time, the first surfaces 411 of the two holding members 40 elastically hold/contact the outer thread 31 of the screw 30. The first surfaces 411 of the holding members 40 are elastically flexed and deformed to hold or engage with the outer thread 31 of the screw 30, whereby the nut 10 and the screw 30 are elastically tightened with each other. Under such circumstance, the nut 10 is prevented from loosening from the screw 30 due to severe vibration. In this case, the loosening of the part of the transportation tool or mechanical apparatus can be avoided so as to ensure safety. FIG. 10 shows another aspect of the holding member 40, which is made of one single material. For example, the holding member 40 is totally made of the first material layer 41. The first material layer 41 is made of a soft, flexible or elastic material for elastically holding the screw/bolt 30. The surface of the holding member 40 that faces the threaded hole 11 slightly protrudes from the receiving cavity 13.

The holding members 40 are axially disposed in the receiving cavities 13 of the nut 10. The first surfaces 411 of the holding members 40 are elastically flexed and deformed to hold or engage with the outer thread 31 of the screw 30, whereby the inner thread 12 of the nut 10 and the outer thread 31 of the screw 30 are elastically tightened with each other. This can eliminate the shortcoming of the prior art in which the C-shaped ring 60 is engaged between the inner thread 611 of the nut 61 and the outer thread 621 of the screw 62. Moreover, the holding members 40 are elastically flexed and deformed to hold the outer thread 31 of the screw 30 rather than engaged with the outer thread 31 of the screw 30. Therefore, when screwing the nut 10 onto the screw 30, the nut 10 will not clog.

According to the above arrangement, at least one elastic holding member is disposed in the threaded hole of the nut to elastically hold the screw/bolt. The holding member is elastically flexed and deformed to hold or engage with the outer thread of the screw, whereby the nut and the screw are elastically tightened with each other. In the present invention, the holding members elastically hold the screw rather than engage therewith so that when screwing the nut onto the screw, the nut will not clog as the conventional structure.

The above embodiments are only used to illustrate the present invention, not intended to limit the scope thereof. Many modifications of the above embodiments can be made without departing from the spirit of the present invention.

What is claimed is:

1. An anti-loosening nut comprising:
a nut formed with a threaded hole, a wall of the threaded hole being formed with at least one receiving cavity formed on the wall of the threaded hole in an axial direction of the threaded hole; and
at least one holding member, which is a leaf spring mounted in the receiving cavity of the nut, the leaf spring being formed with at least one holding section for elastically abutting against a screw.

2. The nut as claimed in claim 1, wherein the holding section of the leaf spring slightly protrudes from the receiving cavity.

3. The nut as claimed in claim 1, wherein at least two receiving cavities are formed on the wall of the threaded hole and arranged at intervals, the leaf spring being formed with at least two holding sections mounted in the receiving cavities of the nut respectively, each holding member being an elongated member, a longitudinal direction of the holding member extending along the axial direction of the threaded hole.

4. The nut as claimed in claim 2, wherein at least two receiving cavities are formed on the wall of the threaded hole and arranged at intervals, the leaf spring being formed with at least two holding sections mounted in the receiving cavities of the nut respectively, each holding member being an elongated member, a longitudinal direction of the holding member extending along the axial direction of the threaded hole.

5. The nut as claimed in claim 3, wherein the receiving cavities of the nut are formed on the wall of the threaded hole and arranged at equal intervals.

6. The nut as claimed in claim 4, wherein the receiving cavities of the nut are formed on the wall of the threaded hole and arranged at equal intervals.

7. An anti-loosening nut comprising:
a nut formed with a threaded hole, a wall of the threaded hole being formed with at least one receiving cavity formed on the wall of the threaded hole in an axial direction of the threaded hole; and
at least one holding member, which has the form of an elongated bar, the holding member having a first surface and a second surface respectively positioned on a front face and a back face of the holding member, the holding member being disposed in the receiving cavity of the nut, a longitudinal direction of the holding member extending along a longitudinal direction of the receiving cavity, the first surface facing the threaded hole and being made of a soft material, the second surface facing the receiving cavity.

8. The nut as claimed in claim 7, wherein the first surface of the holding member has a hardness softer than a hardness of the second surface.

9. The nut as claimed in claim 7, wherein the holding member is composed of a first material layer and a second material layer, the first and second material layers being overlapped and connected with each other, the surface of the first material layer being the first surface; the surface of the second material layer being the second surface; the second material layer having a hardness larger than a hardness of the first material layer.

10. The nut as claimed in claim 7, wherein the first surface of the holding section slightly protrudes from the receiving cavity.

11. The nut as claimed in claim 8, wherein the first surface of the holding section slightly protrudes from the receiving cavity.

12. The nut as claimed in claim 9, wherein the first surface of the holding section slightly protrudes from the receiving cavity.

13. An anti-loosening nut comprising:
a nut formed with a threaded hole, a wall of the threaded hole being formed with at least one receiving cavity formed on the wall of the threaded hole in an axial direction of the threaded hole; and
at least one holding member, which has the form of an elongated bar, the holding member being made of a soft material or an elastic material and disposed in the receiving cavity of the nut, a longitudinal direction of the holding member extending along a longitudinal direction of the receiving cavity.

14. The anti-loosening nut as claimed in claim 13, wherein a surface of the holding member that faces the threaded hole slightly protrudes from the receiving cavity.
